(19) United States
(12) Patent Application Publication
(10) Pub. No.: US 2006/0077840 A1
(43) Pub. Date: Apr. 13, 2006

(54) Disk area detection method and apparatus

(75) Inventors: Byung-In Ma, Suwon-si (KR); Kwan-Joon Kim, Taean-eup (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/214,879

(22) Filed: Aug. 31, 2005

(30) Foreign Application Priority Data
Sep. 2, 2004 (KR) 2004-69998

(51) Int. Cl. G11B 7/00

(52) U.S. Cl. 369/53.1; 369/53.2; 369/124.01

(57) ABSTRACT

A disk area type detection method and apparatus, the disk area type detection method including detecting the difference between a side push-pull (SPP) 1 signal and an SPP2 signal; and determining whether an area is a storage medium related information area or a user data area on the disk, based on the detected difference. According to the method and apparatus, the user data area and the storage medium related information area of the disk can be easily distinguished, allowing phase locked loop (PLL) control to be performed appropriately.

### CROSS-REFERENCE TO RELATED APPLICATION

This application claims the priority of Korean Patent Application No. 2004-69998, filed on Sep. 2, 2004 in the Korean Intellectual Property Office, the disclosure of which is incorporated herein by reference.

### BACKGROUND OF THE INVENTION

1. Field of the Invention

The present invention relates to a disk, and more particularly, to a disk area type detection method and apparatus.

2. Description of the Related Art

Optical information storage media, such as optical disks, are widely used, in conjunction with an optical pickup apparatus which can record and reproduce information without physical contact.

Compact disks (CDs) and digital versatile disks (DVDs) are two types of optical disks, each with different recording capacity. Optical disks can also be broken down into read-only disks and recordable disks. Examples of the former are the 650 MB CD and the 4.7 GB DVD-ROM. Examples of the latter are the 650 MB CD-recordable (R) and CD-rewritable (RW), and the 4.7 GB DVD+R/RW, DVD-RAM and DVD-R/RW. Furthermore, a high-density optical disk (HD-DVD) with a recording capacity of 23 GB or more is under development.

An ordinary optical information storage medium employs a method by which data is recorded in the form of pits or a groove wobble. Here, the pits are openings formed through engraving a substrate during manufacture, and a pit signal is detected as a jitter value. The groove wobble is a groove formed on a substrate in the form of a wave, and a groove wobble signal is detected as a push-pull signal.

FIG. 1 illustrates an example of an optical information storage medium according to the conventional technology.

Referring to FIG. 1, a conventional high-density rewritable optical recording information storage medium includes a user data area 120 in which user data is recorded, a lead-in area 110 inside the user data area, and a lead-out area 130 outside the user data area. A storage medium related information area 111 occupies all or part of the lead-in area 110, and stores data only for reproduction such as storage medium related information. This data only for reproduction is formed as a high frequency wobble. The recordable area which covers part of the lead-in area 110, the data area 120, and the lead-out area 130 is formed as a relatively low frequency wobble, and in this groove user data can be recorded. Thus, since the wobble format of the user data area is different from that of the storage medium related information area, PLL conditions must be changed before the stored data can be read. Accordingly, it is required to change PLL conditions by determining whether a laser beam is projected to the user data area or to the storage medium related information area.

Meanwhile, a push-pull signal generation method according to the conventional technology will now be explained briefly.

FIGS. 2A through 2C illustrate a push-pull signal generation method according to the conventional technology.

In a DPP method, a diffraction unit is aligned with a beam from a laser light source, and three spots by three beams of ninth order diffracted light (main beam) and first order diffracted light (side beams) are formed on an optical disk. Reflected light from each spot is received by a corresponding photo detector, and the main spot by the main beam is used for recording or reading a signal, while side spots by side beams are used for detecting tracking errors.

In the DPP method, by using the main spot and two side spots, a tracking error signal is generated. Referring to FIG. 2B, a main photo detector 23 receives light from the main spot. The photo detector 23 is divided in four parts in a vertical and horizontal direction. Referring to FIGS. 2A and 2C, each of two side photo detectors 21 and 25 receives light from the side spots and each photo detector 21 and 25 is divided in two parts in a horizontal direction. When output signals of the photo detectors are denoted by A, B, C, D, E, F, G, and H, respectively, a tracking error signal is obtained as the following equations:
MPP=(B+C)−(A+D)
SPP1=E−F
SPP2=G−H
DPP=MPP−k(SPP1+SPP2)

Here, the main push-pull (MPP) signal is the diagonal difference of signals generated in the main photo detector, and side push-pull (SPP)1 and SPP2 are the differences of signals generated in the respective side photo detectors. Also, k denotes a coefficient, and DPP denotes a tracking error signal generated by the DPP method.

Referring to FIG. 2A, a first subtractor 22 performs subtraction of E and F signals generated in the first side photo detector 21, to generate the SPP1 signal, and a third subtractor 26 performs subtraction of G and H signals generated in the second side photo detector 25, to generate the SPP2 signal. Meanwhile, the second subtractor 24 uses A, B, C, and D signals generated in the main photo detector 23 to generate the MPP signal given as MPP=(B+C)−(A+D).

### SUMMARY OF THE INVENTION

According to an aspect of the present invention, there is provided a disk area type detection method and apparatus enabling simple identification of a disk area type.

According to another aspect of the present invention, there is provided a disk area type detection method including detecting the difference between a side push-pull (SPP) 1 signal and an SPP2 signal based on the signals reflected from the disk; and determining whether an area of the disk is a storage medium related information area or a user data area, based on the detected difference.

According to another aspect of the present invention, the detecting of the difference may include detecting the peak-to-peak value of (SPP1−SPP2). At this time, determining the area type may include: if the peak-to-peak value of (SPP1−SPP2) exceeds a predetermined threshold, determining that the area is a storage medium related information area.

According to another aspect of the present invention, the detecting of the difference may include detecting the phase difference between SPP1 and SPP2. At this time, determining the area type may further include: if the phase difference is output as direct current (DC), determining that the area is a storage medium related information area.

According to another aspect of the present invention, the method may further include outputting a phase locked loop (PLL) condition based on the determination result, to a PLL.

According to another aspect of the present invention, there is provided a disk area type detection apparatus for detecting the type of an area of a disk, including a difference signal detection unit which detects the difference between an SPP1 signal and an SPP2 signal based on the signals reflected from the disk; and an area determination unit which determines whether an area on the disk is a storage medium related information area or a user data area, based on the detected difference.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates an example of an optical information storage medium according to the conventional technology;

FIGS. 2A through 2C illustrate a push-pull signal generation method according to the conventional technology;

FIGS. 3A and 3B illustrate the phase relationship of sub-beams to explain the concept of determining a storage medium related information area according to an embodiment of the present invention;

FIG. 4 is a diagram of the structure of an optical recording and/or reproducing apparatus including an area detection unit according to an embodiment of the present invention;

FIG. 5 illustrates an embodiment of an area detection unit shown in FIG. 4;

FIG. 6 illustrates another embodiment of an area detection unit shown in FIG. 4;

FIGS. 7A and 7B show graphs comparing (SPP1−SPP2) signals of a user data area and a storage medium related information area in an off-track state;

FIGS. 8A through 8D show graphs comparing (SPP1−SPP2) signals in R-tilt change;

FIGS. 9A through 9D show graphs comparing (SPP1−SPP2) signals in T-tilt change; and

FIGS. 10A and 10B show graphs of phase difference signals of a user data area and a storage medium related information area in an off-track state.

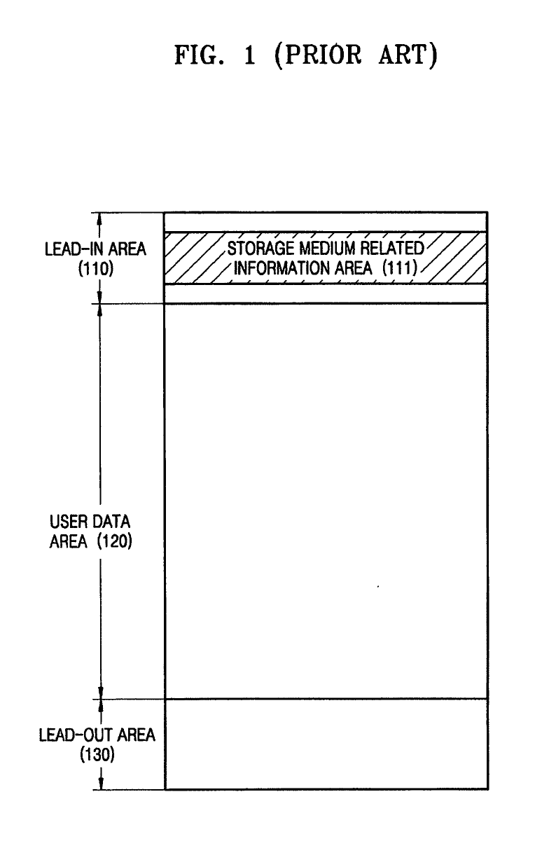

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

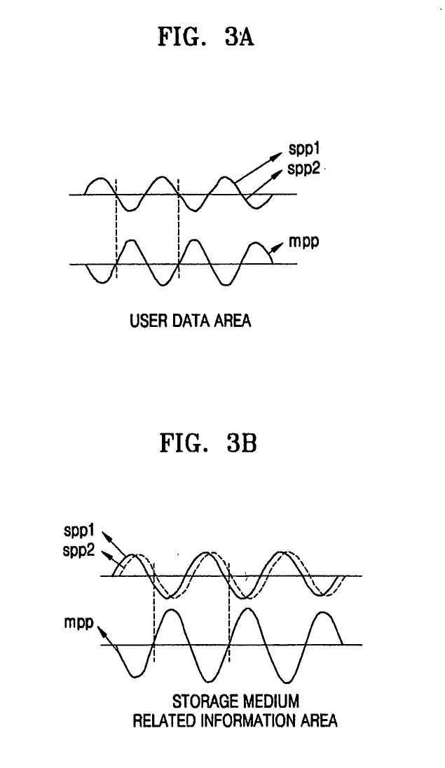

Referring to FIG. 3A, it can be seen that SPP1 and SPP2 in the user data area correspond exactly, whereas in FIG. 3B, there is a phase difference between SPP1 and SPP2 in the storage medium related information area.

Accordingly, to an embodiment of the present invention is based on the fact that a user data area can be distinguished from a storage medium related information area by detecting the phase difference of sub-beams SPP1 and SPP2.

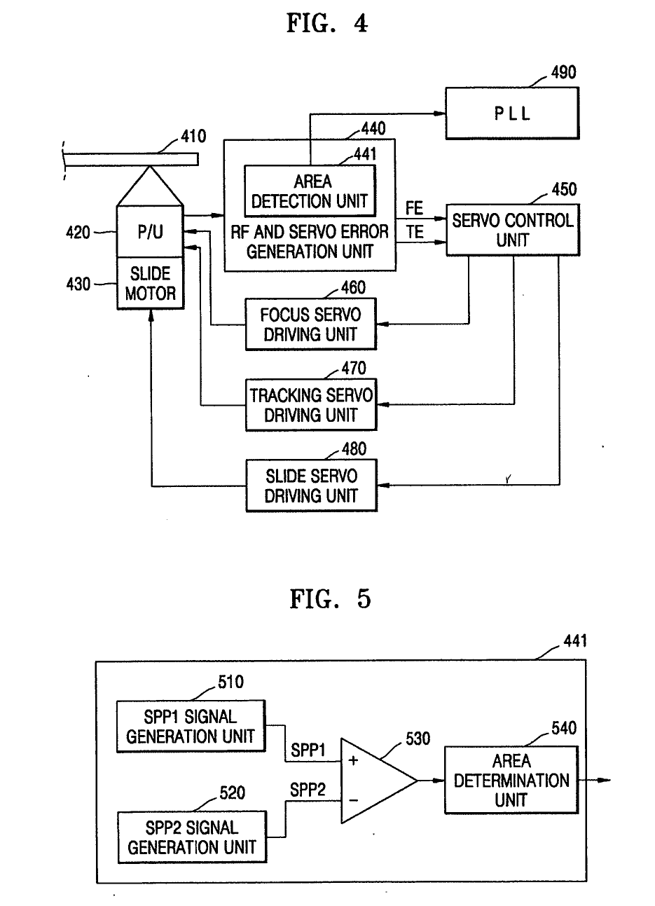

FIG. 4 is a diagram of the structure of an optical recording and/or reproducing apparatus including an area detection unit according to an embodiment of the present invention.

The optical recording and/or reproducing apparatus to which the present invention is applied includes an optical disk 410, a pickup 420, an RF and servo error generation unit 440, a servo control unit 450, a focus servo driving unit 460, a tracking servo driving unit 470, a slide servo driving unit 480, a slide motor 430, and a PLL 490.

The pickup 420 includes an optical system including a laser diode, an optical detector, a variety of lenses, and a focus/tracking actuator. According to tracking and focus control of the servo control unit 450, a light beam is condensed onto an object lens, and the pickup 420 directs the light beam onto the track of the optical disk 410. Also, light reflected from the recording surface of the optical disk 410 is condensed again onto the object lens and directed onto the optical detector, in order to detect a focus error signal and a tracking error signal.

The photo detector includes a plurality of photo detecting devices and outputs an electric signal in proportion to the amount of light obtained by each photo detecting device, to the RF and servo error generation unit 440.

The RF and servo error generation unit 440 generates an RF signal for reproducing data, a focus error (FE) signal and a tracking error (TE) signal for servo control, from the electrical signal output from each photo detecting device of the photo detector.

The generated RF signal is output to a data decoder (not shown), and the focus error (FE) signal and the tracking error (TE) signal are output to the servo control unit 450.

The servo control unit 450 processes the focus error (FE) signal and outputs a driving signal for focusing control, to the focus servo driving unit 460, and processes the tracking error (TE) signal and outputs a driving signal for tracking control, to the tracking servo driving unit 470.

The focus servo driving unit 460 moves the pickup 420 up and down to follow the disk, by driving the focus actuator in the pickup 420 such that a focus is formed on the surface of the disk 410 according to the upward and downward movement together with the rotation of the disk 410.

The tracking servo driving unit 470 moves the object lens of the pickup 420 radially by driving the tracking actuator in the pickup 420, such that the beam follows the track.

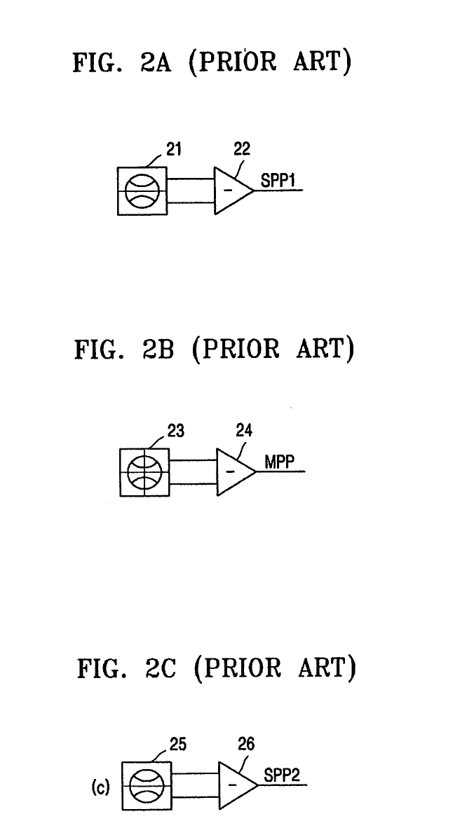

The RF and servo error generation unit 440 includes a tracking error signal generation circuit and also an area detection unit 441, which detects whether the pickup 420 is in the user data area or in the storage medium related information area of the disk according to an embodiment of the present invention. For convenience of explanation, it is assumed that the photo detector embedded in the pickup 420 has the structure shown in FIG. 2, but it is obvious that a variety of types of photo detector can be applied to the present invention as well as the type shown in FIG. 2.

FIG. 5 illustrates an embodiment of an area detection unit shown in FIG. 4.

Referring to FIG. 5, an area detection unit 441 includes an SPP1 signal generation unit 510, an SPP2 signal generation unit 520, a subtraction unit 530, and an area determination unit 540.

The SPP1 signal generation unit 510 subtracts the F signal from the E signal, and generates and outputs the SPP1 signal.

The SPP2 signal generation unit 520 subtracts the H signal from the G signal and generates and outputs the SPP2 signal.

The subtraction unit 530 receives the SPP1 signal and the SPP2 signal, subtracts the SPP2 signal from the SPP1 signal, and outputs the result to the area determination unit 540.

If the peak-to-peak value of the signal resulting from subtracting the SPP2 signal from the SPP1 signal is less than a predetermined threshold value, the area determination unit 540 determines that the pickup is in the user data area, and if the resulting value is greater than the predetermined threshold, the area determination unit 540 determines that the pickup is in the storage medium related information area. Then, the area determination unit 540 outputs PLL control condition information according to the determined area, to the PLL 490.

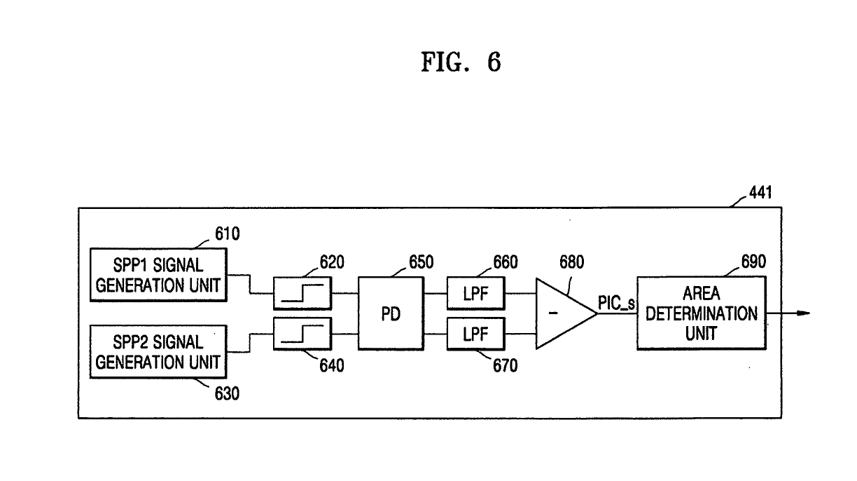

FIG. 6 illustrates another embodiment of an area detection unit shown in FIG. 4.

Referring to FIG. 6, the area detection unit 441 includes an SPP1 signal generation unit 610, a binarization unit 620, an SPP2 signal generation unit 630, a binarization unit 640, a phase detection unit 650, a low pass filter (LPF) 660, a LPF 670, a subtraction unit 680, and an area determination unit 690.

The SPP1 signal generation unit 610 subtracts the F signal from the E signal and generates and outputs the SPP1 signal, and the binarization unit 620 binarizes the SPP1 signal and outputs the result to the phase detection unit 650.

The SPP2 signal generation unit 630 subtracts the H signal from the G signal and generates and outputs the SPP2 signal, and the binarization unit 640 binarizes the SPP2 signal and outputs the result to the phase detection unit 650.

The phase detection unit 650 receives the binarized SPP1 and SPP2 signals and detects the phase difference. If the phase of the SPP1 signal is greater, the phase difference is output to the LPF 660, and if the phase of the SPP2 signal is greater, the phase difference is output to the LPF 670.

The LPF 660 and the LPF 670 filter any received signal from the phase detection unit 650, and output the result to the subtraction unit 680.

The subtraction unit 680 subtracts the output signal from the LPF 670 from the output signal from the LPF 660, and outputs the subtraction result PIC_s to the area determination unit 690.

If the received PIC_s value is close to 0, the area determination unit 690 determines that the pickup is within the user data area, and if the value is a predetermined positive or negative value, the area determination unit 690 determines that the pickup is within the storage medium related information area.

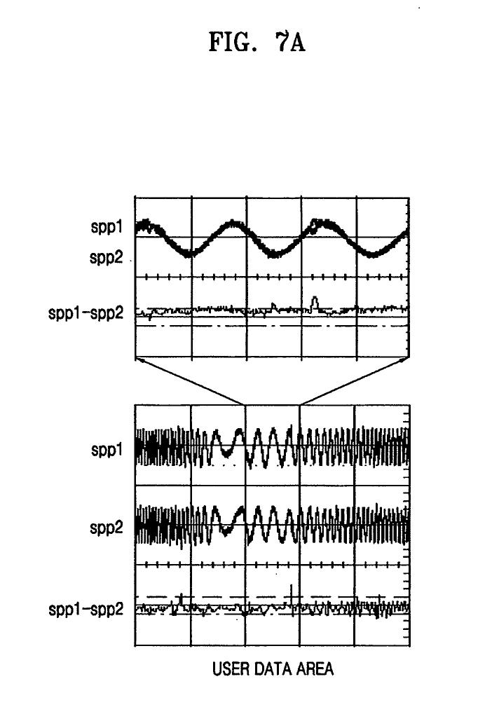

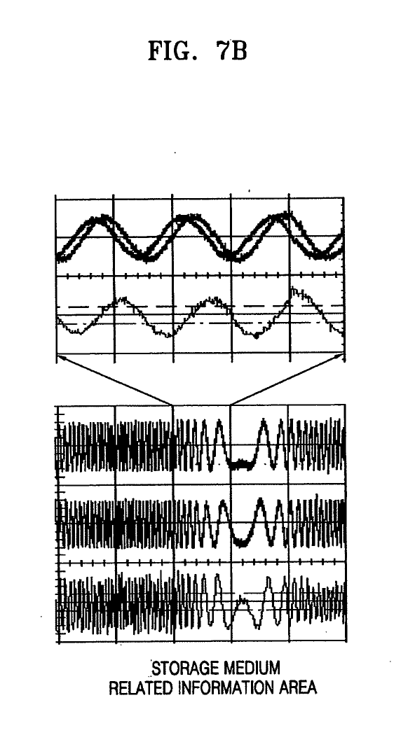

FIGS. 7A and 7B show graphs comparing (SPP1−SPP2) signals of a user data area and a storage medium related information area in an off-track state.

Referring to FIG. 7A, since SPP1 and SPP2 are almost identical in the user data area, it can be seen that (SPP1−SPP2) is between predetermined upper and lower limits. That is, it can be seen that the peak-to-peak value is close to 0.

Meanwhile, referring to FIG. 7B, since there is a phase difference between SPP1 and SPP2 in the storage medium related information area, (SPP1−SPP2) appears in the form of a sine wave, and accordingly it can be seen that the peak-to-peak value exceeds a predetermined threshold value.

Accordingly, if the peak-to-peak value of (SPP1−SPP2) is less than a predetermined threshold value, it can be determined that the pickup is in the user data area, and if the peak-to-peak value is greater than the predetermined threshold value, it can be determined that the pickup is in the storage medium related information area.

Thus, determining the area by using the difference between SPP1 and SPP2 can also be applied when the disk is tilted.

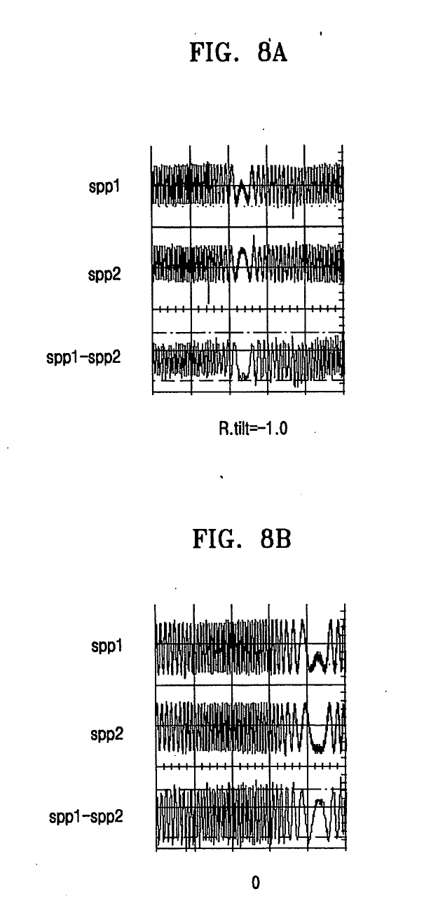

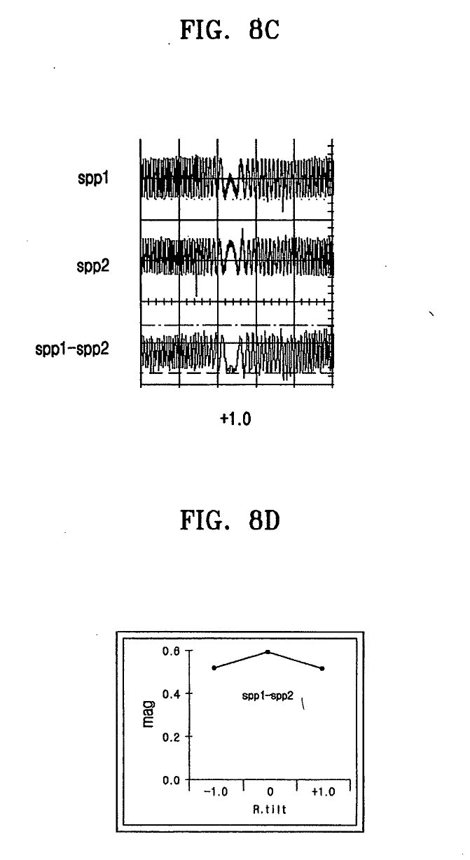

FIGS. 8A through 8D show graphs comparing (SPP1−SPP2) signals in R-tilt change.

Referring to FIGS. 8A through 8D, since all the peak-to-peak values of (SPP1−SPP2) exceed a predetermined threshold when R-tilt is −1.0 as shown in FIG. 8A, 0 as shown in FIG. 8B, and +1.0 as shown in FIG. 8C, it can be determined that the pickup is in the storage medium related information area.

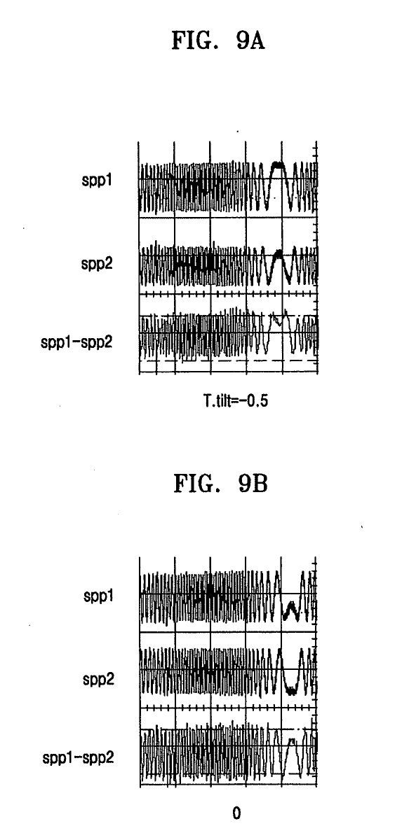

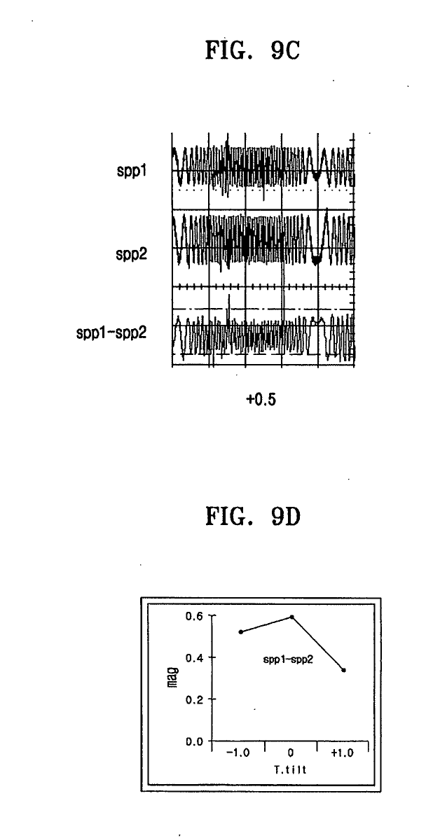

FIGS. 9A through 9D show graphs comparing (SPP1−SPP2) signals in T-tilt change.

Referring to FIGS. 9A through 9D, since all the peak-to-peak values of (SPP1−SPP2) exceed a predetermined threshold when T-tilt is −0.5 as shown in FIG. 9A, 0 as shown in FIG. 9B, and +0.5 as shown in FIG. 9C, it can be determined that the pickup is in the storage medium related information area.

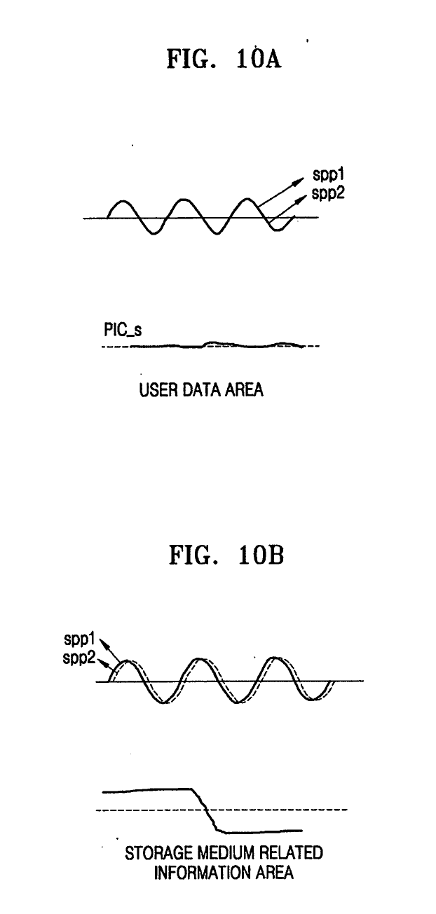

FIGS. 10A and 10B show graphs of phase difference signals of a user data area and a storage medium related information area in an off-track state.

FIG. 10A shows the PIC_s signal of the user data area, and FIG. 10B shows the PIC_s signal of the storage medium related information area.

Referring to FIG. 10A, in the user data area, PIC_s approaches zero.

Referring to FIG. 10B, in the storage medium related information area, PIC_s becomes vcc*0.2 or −vcc*0.2. The polarity changes according to the movement direction of the laser beam. Thus, when PIC_s approaches 0, it can be determined that the pickup is in the user data area, and when PIC_s exceeds a predetermined positive or negative value, it can be determined that the pickup is in the storage medium related information area.

Meanwhile, in an on track state, by detecting (SPP1−SPP2) and determining whether the value is DC, it can be simply determined whether or not the pickup is in the storage medium related information area.

While the present invention has been particularly shown and described with reference to exemplary embodiments thereof, it will be understood by those of ordinary skill in the art that various changes in form and details may be made therein without departing from the spirit and scope of the present invention as defined by the following claims.

According to the present invention as described above, the user data area can be easily distinguished from the storage medium related information area, allowing appropriate PLL control to be performed.

What is claimed is:

1. A disk area type detection method comprising:
detecting a difference between a side push-pull (SPP) 1 signal and an SPP2 signal based on signals reflected from the disk; and
determining whether an area on the disk is a storage medium related information area or a user data area, based on the difference.

2. The method of claim 1, wherein detecting the difference comprises:
detecting a peak-to-peak value of (SPP1−SPP2).

3. The method of claim 2, wherein the determining the disk area type comprises:
if the peak-to-peak value of (SPP1−SPP2) exceeds a predetermined threshold, determining that the area of the disk is a storage medium related information area.

4. The method of claim 1, wherein detecting the difference comprises:
detecting a phase difference between SPP1 and SPP2.

5. The method of claim 4, wherein the determining the area type further comprises:
if the phase difference is output as direct current (DC), determining that the area of the disk is a storage medium related information area.

6. The method of claim 1, further comprising:
outputting a phase locked loop (PLL) condition, based on the determination of whether the area is the storage medium related information area or the user date area, to a PLL.

7. A disk area type detection apparatus detecting a type of an area of a disk, comprising:
a difference signal detection unit which detects a difference between a side push-pull (SPP)1 signal and a SPP2 signal based on signals reflected from the disk; and
an area determination unit which determines whether an area is a storage medium related information area or a user data area on the disk, based on the detected difference.

8. The apparatus of claim 7, wherein the difference signal detection unit detects a peak-to-peak value of (SPP1−SPP2).

9. The apparatus of claim 8, wherein if the peak-to-peak value of (SPP1−SPP2) exceeds a predetermined threshold, the area determination unit determines that the area is the storage medium related information area.

10. The apparatus of claim 7, wherein the difference signal detection unit detects a phase difference between SPP1 and SPP2.

11. The apparatus of claim 10, wherein if the phase difference is output as direct current (DC), the area determination unit determines that the area is the storage medium related information area.

12. The apparatus of claim 7, wherein the area determination unit further outputs a phase locked loop (PLL) condition based on the determination result, to a PLL.

13. The apparatus of claim 7, wherein the difference signal detection unit comprises an SPP1 signal generation unit, an SPP2 signal generation unit and a subtraction unit.

14. The apparatus of claim 7, wherein the difference signal detection unit further comprises a first binarization unit, a second binarization unit, a phase detection unit, a first low pass filter, a second low pass filter and a subtraction unit.

15. The apparatus of claim 14, wherein the phase detection unit receives binarized SPP1 and SPP2 signals and detects a phase difference between the signals.

16. The apparatus of claim 15, wherein if a phase of the SPP1 signal is greater than a phase of the SPP2 signal, the phase difference is output to the first low pass filter.

17. The apparatus of claim 16, wherein if the phase of the SPP2 signal is greater than the phase of the SPP1 signal, the phase difference is output to the second low pass filter.

18. The apparatus of claim 14, wherein the subtraction unit subtracts an output signal from the second low pass filter from an output signal of the first low pass filter and outputs the subtraction result to the area determination unit.

19. The apparatus of claim 18, wherein if the subtraction result is approximately 0, the area determination unit determines that the area is the user data area and if the subtraction result is a predetermined positive or negative value, the area determination unit determines that the area is the storage medium related information area.

20. The apparatus of claim 14, wherein the first binarization unit binarizes the SPP1 signal and outputs the result to the phase detection unit and the second binarization unit binarizes the SPP2 signal and outputs the result to the phase detection unit and the phase detection unit detects the phase difference based on the output results.

21. A disk area type detection method comprising:
detecting a phase difference between a first signal and a second signal based on signals reflected from the disk; and
determining whether an area on the disk is a first type area or a second type area, based on the phase difference between first and second signals.
